(19) United States
(12) Patent Application Publication
(10) Pub. No.: US 2023/0353882 A1
(43) Pub. Date: Nov. 2, 2023

(54) IMAGING CONTROL DEVICE, IMAGING CONTROL METHOD, AND MOBILE BODY

(71) Applicant: SONY SEMICONDUCTOR SOLUTIONS CORPORATION, KANAGAWA (JP)

(72) Inventor: TAKAFUMI ASAHARA, KANAGAWA (JP)

(21) Appl. No.: 18/044,801

(22) PCT Filed: Aug. 30, 2021
(86) PCT No.: PCT/JP2021/031787

§ 371 Date: Mar. 10, 2023

(30) Foreign Application Priority Data
Sep. 25, 2020 (JP) 2020-160881

(51) Int. Cl. H04N 23/73; H04N 23/71

(52) U.S. Cl. CPC H04N 23/73; H04N 23/71

(57) ABSTRACT

An imaging control device of the present disclosure includes: a detector circuit that sets a detection frame in an imaging screen of a first camera that is movable, and performs detection of brightness of an image captured by the first camera; an exposure controller that calculates an exposure control parameter to be used for exposure control on the first camera on the basis of a detection result by the detector circuit; and a detection controller that changes a state of detection by the detector circuit on the basis of a moving direction of the first camera that is moving.

### TECHNICAL FIELD

The present disclosure relates to an imaging control device, an imaging control method, and a mobile body that control a movable camera.

### BACKGROUND ART

Cameras have a function of performing automatic exposure control (Auto Exposure) to maintain constant brightness of a screen (see PTLs 1 to 3). A typical mechanism of the automatic exposure control is to detect an amount of light entering an image sensor by a detector circuit and control a gain amount (sensitivity) to have target brightness. Meanwhile, many mobile bodies such as a robot and a drone are equipped with cameras.

### CITATION LIST

### Patent Literature

PTL 1: Japanese Unexamined Patent Application Publication No. 2014-27587
PTL 2: Japanese Unexamined Patent Application Publication No. 2013-126091
PTL 3: Japanese Unexamined Patent Application Publication No. 2004-7580

### SUMMARY OF THE INVENTION

For example, in a case where a camera-equipped device such as a mobile body performs turning movement or the like at high speed, a sudden change in brightness of a subject causes shooting in an inappropriate exposure state, which lowers performance of object detection or the like until the exposure state become appropriate.

It is desirable to provide an imaging control device, an imaging control method, and a mobile body that make it possible to perform appropriate exposure control even in a case where a camera moves.

An imaging control device according to an embodiment of the present disclosure includes: a detector circuit that sets a detection frame in an imaging screen of a first camera that is movable, and performs detection of brightness of an image captured by the first camera; an exposure controller that calculates an exposure control parameter to be used for exposure control on the first camera on the basis of a detection result by the detector circuit; and a detection controller that changes a state of detection by the detector circuit on the basis of a moving direction of the first camera that is moving.

An imaging control method according to an embodiment of the present disclosure includes: setting a detection frame in an imaging screen of a first camera that is movable and performing detection of brightness of an image captured by the first camera; calculating an exposure control parameter to be used for exposure control on the first camera on the basis of a detection result of the brightness; and changing a state of the detection on the basis of a moving direction of the first camera that is moving.

A mobile body according to an embodiment of the present disclosure includes: a first camera; a detector circuit that sets a detection frame in an imaging screen of the first camera, and performs detection of brightness of an image captured by the first camera; an exposure controller that calculates an exposure control parameter to be used for exposure control on the first camera on the basis of a detection result by the detector circuit; and a detection controller that changes a state of detection by the detector circuit on the basis of a moving direction of the first camera that is moving.

In the imaging control device, the imaging control method, and the mobile body according to the embodiments of the present disclosure, in a case where the exposure control parameter to be used for exposure control on the first camera is calculated on the basis of the detection result of brightness of the image captured by the first camera that is movable, the state of detection is changed on the basis of the moving direction of the first camera that is moving.

### BRIEF DESCRIPTION OF DRAWINGS

FIG. 1 is a schematic top view of a configuration example of a mobile body according to a first embodiment of the present disclosure.

FIG. 2 is a block diagram schematically illustrating a configuration example of an imaging control device according to the first embodiment.

FIG. 3 is an explanatory diagram schematically illustrating a first example of control of a detection state by the imaging control device according to the first embodiment.

FIG. 4 is an explanatory diagram schematically illustrating a second example of control of the detection state by the imaging control device according to the first embodiment.

FIG. 5 is an explanatory diagram schematically illustrating a third example of control of the detection state by the imaging control device according to the first embodiment.

FIG. 6 is a flowchart schematically illustrating an example of a flow of an exposure control process by the imaging control device according to the first embodiment.

FIG. 7 is a schematic top view of an example of a moving state of the mobile body according to the first embodiment.

FIG. 8 is an explanatory diagram schematically illustrating an example of a method of estimating brightness information about another camera.

### MODES FOR CARRYING OUT THE INVENTION

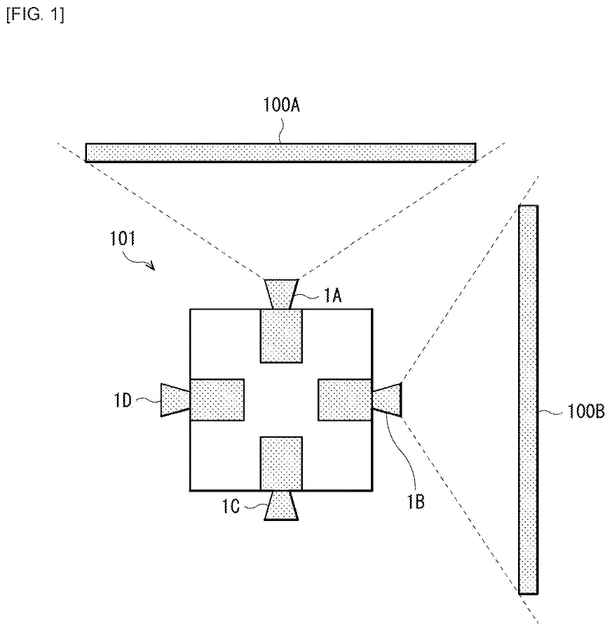

In the following, some embodiments of the present disclosure are described in detail with reference to the drawings. It is to be noted that description is given in the following order.
1. First Embodiment (FIGS. 1 to 8)
1.1 Configuration
1.2 Operation
1.3 Effects
2. Other Embodiments

### 1. First Embodiment

[1.1 Configuration]

FIG. 1 schematically illustrates a configuration example of a mobile body 101 according to a first embodiment of the present disclosure. FIG. 1 illustrates a configuration example of the mobile body 101 as viewed from above.

The mobile body 101 is, for example, a drone that is freely movable in up, down, right and left directions, and includes a first camera 1A, a second camera 1B, a third camera 1C, and a fourth camera 1D. It is to be noted that FIG. 1 illustrates a configuration example provided with four cameras; however, a configuration provided with less than four cameras or more than four cameras may be adopted. In addition, the mobile body 101 is not limited to a drone, and may be a robot or the like.

Each of cameras is integrated with the mobile body 101 to be movable with the mobile body 101, and imaging directions of the cameras are changed with movement of the mobile body 101. The cameras are different in imaging direction from each other, and are able to capture images of subjects located in different directions. For example, the imaging directions of the first camera 1A and the second camera 1B are different by about 90° in a plane. This makes it possible for the first camera 1A and the second camera 1B to capture images of a first subject 100A and a second subject 100B located in directions different by about 90° in the plane. It is to be noted that the imaging directions of the respective cameras are not limited to the example illustrated in FIG. 1, and the cameras may be able to capture images in other directions.

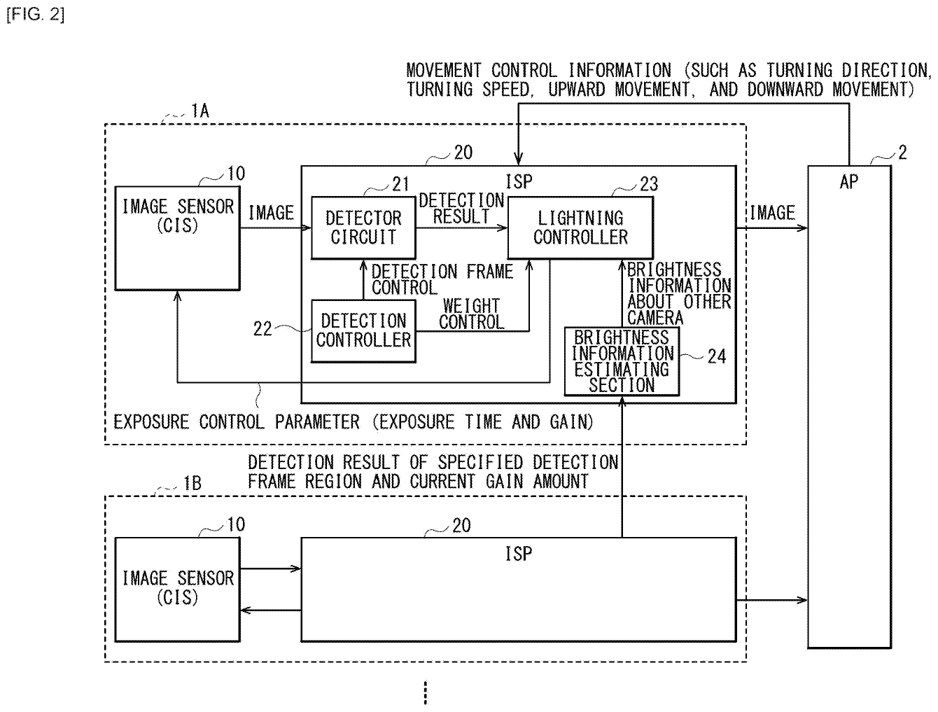

FIG. 2 schematically illustrates a configuration example of an imaging control device according to the first embodiment.

It is to be noted that the configuration of an imaging control device that controls the first camera 1A illustrated in FIG. 1 is described below as an example with reference to FIG. 2; however, an imaging control device of another camera may have a similar configuration.

In addition, for convenience of description, hereinafter, the first camera 1A and the second camera 1B are also respectively referred to as “camera of interest” and “other camera”. It is to be noted that in the configuration example in FIG. 1, for example, the fourth camera 1D may also be the other camera with respect to the first camera 1A.

The mobile body 101 includes an AP (application processor) 2. The AP 2 performs movement control on the mobile body 101. Movement control information about the mobile body 101 is inputted to the imaging control device of each of the cameras. Examples of the movement control information about the mobile body 101 include information about movement such as a turning direction, turning speed, upward movement, and downward movement.

It is to be noted that the mobile body 101 may have, for example, a configuration in which movement is controlled wirelessly from outside. In this case, movement control information included in a control signal from a remote control (remote controller) or the like may be directly inputted to the imaging control device of each of the cameras.

The first camera 1A includes an image sensor 10 and an ISP (Image Signal Processor) 20.

The image sensor 10 includes, for example, a CMOS (Complementary Metal Oxide Semiconductor) image sensor (CIS).

The ISP 20 includes, for example, an image processor such as a DSP (Digital Signal Processor). The ISP 20 includes a detector circuit 21, a detection controller 22, an exposure controller 23, and a brightness information estimating section 24.

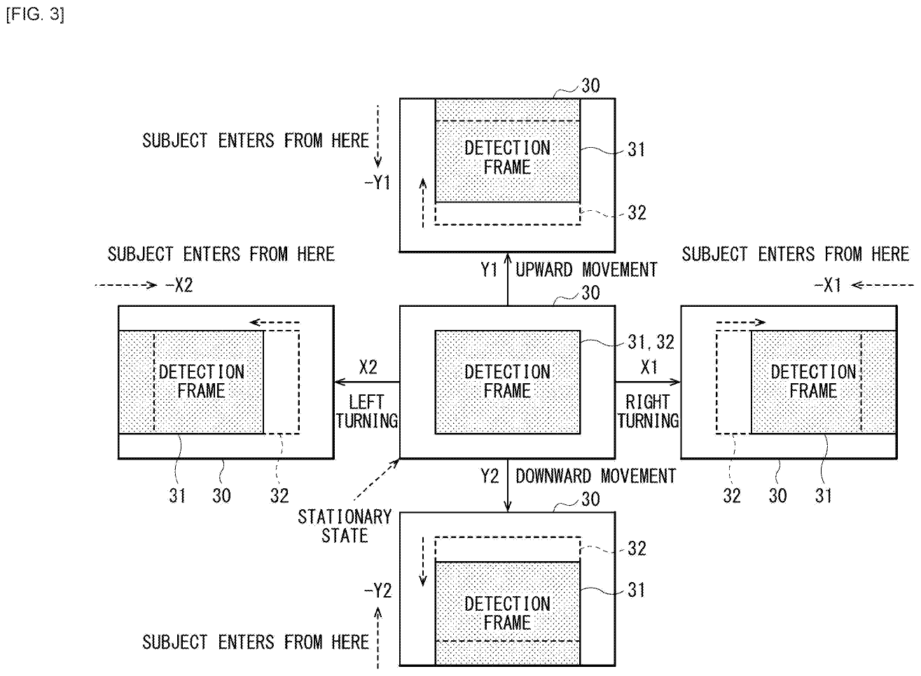

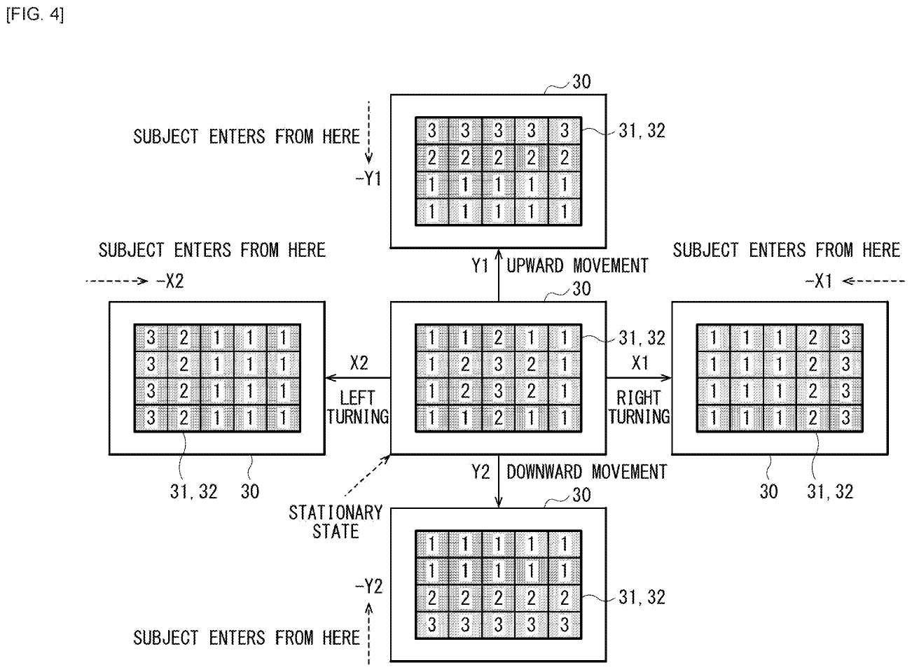

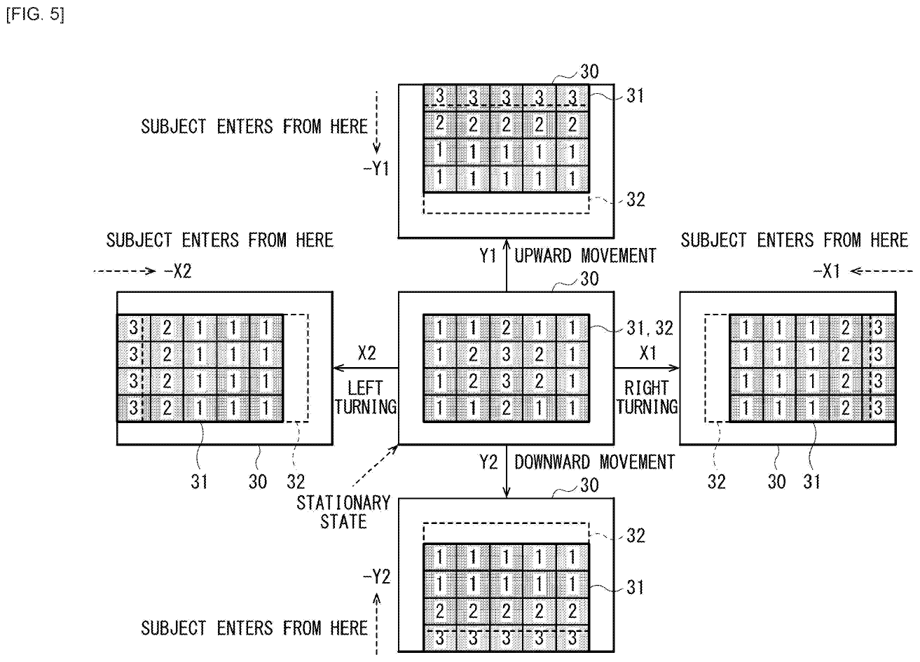

Captured image data from the image sensor 10 of the camera of interest is inputted to the detector circuit 21. For example, as illustrated in examples in FIGS. 3 to 5 to be described later, the detector circuit 21 sets a detection frame 31 in an imaging screen of the image sensor 10 of the camera of interest, and detects brightness of an image captured by the image sensor 10 of the camera of interest. The detector circuit 21 accumulates luminance values in the detection frame 31, and generates current brightness information in the camera of interest. As illustrated in the examples in FIGS. 4 and 5 to be described later, the detector circuit 21 may set a plurality of detection regions in the detection frame 31 and detect brightness in each of the plurality of detection regions.

The detection controller 22 controls a state of detection by the detector circuit 21. The detection controller 22 changes the state of detection by the detection circuit 21 on the basis of a moving direction of the camera of interest that is moving (the moving direction of the mobile body 101).

The detection controller 22 performs weight control for changing a detection weight on each of the plurality of detection regions as the state of detection on the basis of the moving direction of the camera of interest that is moving (the moving direction of the mobile body 101), for example, as illustrated in the example in FIG. 4 to be described later. In this case, the detection controller 22 performs, for example, weight control for increasing the weight on a detection region on side of the moving direction of the camera of interest.

Alternatively, the detection controller 22 performs control for changing the position of the detection frame 31 in an imaging screen of the camera of interest as the state of detection on the basis of the moving direction of the camera of interest that is moving (the moving direction of the mobile body 101), for example, as illustrated in the example in FIG. 3 to be described later. In this case, the detection controller 22 performs, for example, control for moving the position of the detection frame 31 to side of the moving direction of the camera of interest in the imaging screen of the camera of interest.

Alternatively, the detection controller 22 may perform weight control for changing the detection weight on each of the plurality of detection regions and control for changing the position of the detection frame 31 in the imaging screen as the state of detection on the basis of the moving direction of the camera of interest that is moving (the moving direction of the mobile body 101), for example, as illustrated in the example in FIG. 5 to be described later.

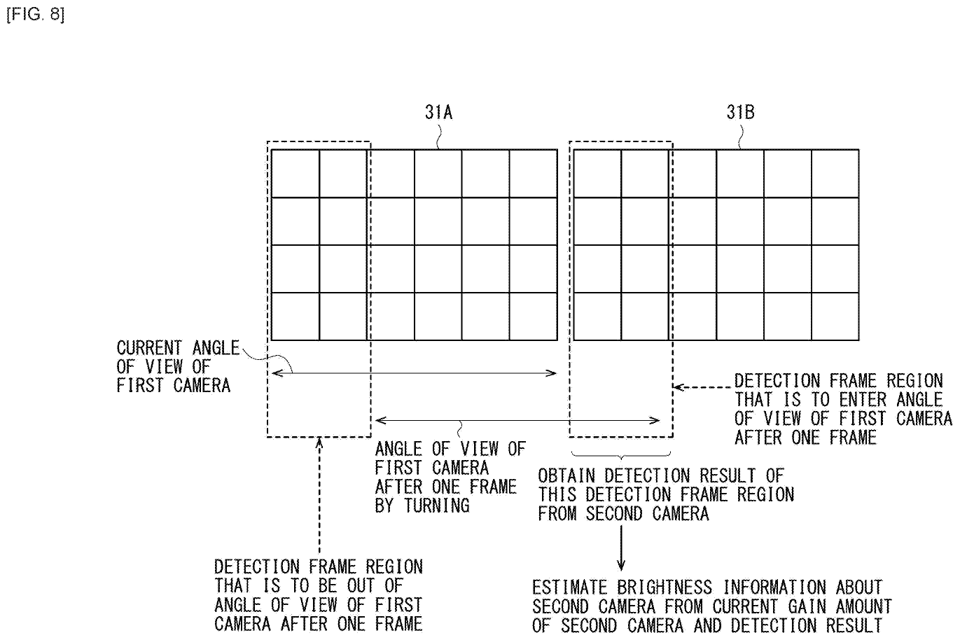

For example, as illustrated in an example in FIG. 8 to be described later, the brightness information estimating section 24 estimates brightness information about the other camera in a case where it is expected to include a future imaging range of the camera of interest in a current imaging screen of the other camera. As illustrated in the example in FIG. 8 to be described later, the brightness information estimating section 24 obtains, from the ISP 20 of the other camera, a detection result of a specified detection frame region of the other camera and a current gain amount of the other camera, and estimates brightness information about the other camera.

The exposure controller 23 calculates an exposure control parameter to be used for exposure control on the camera of interest in the next frame on the basis of a detection result by the detector circuit 21 of the camera of interest. The exposure controller 23 sets the calculated exposure control parameter in the image sensor 10 of the camera of interest. Examples of the exposure control parameter include exposure time and a gain.

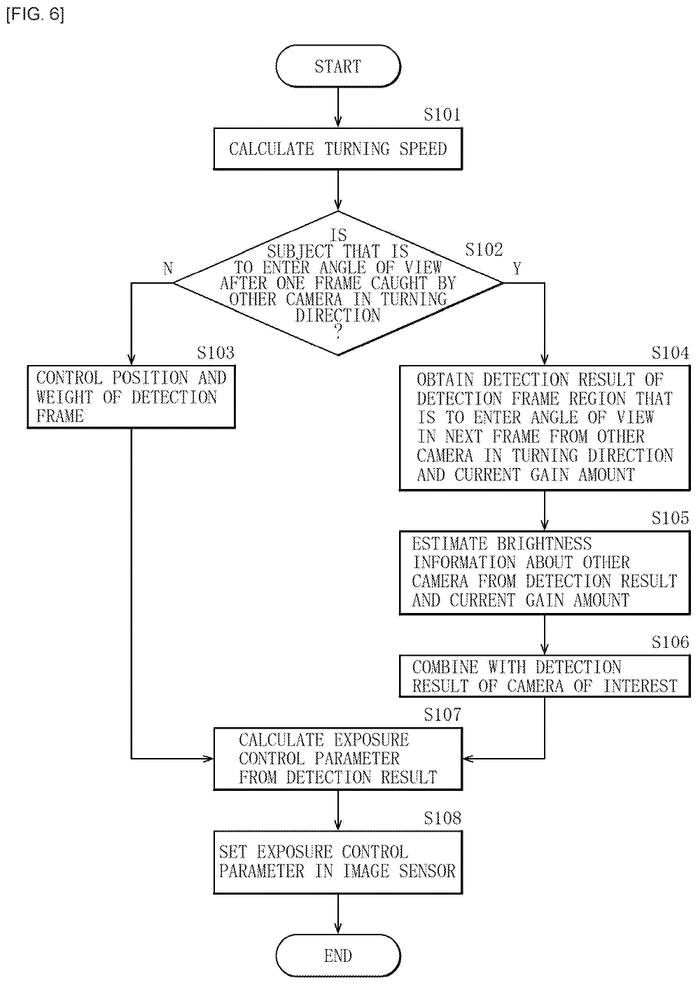

As illustrated in an example of an exposure control process in FIG. 6 to be described later, the exposure controller 23 may calculate the exposure control parameter to be used for exposure control on the camera of interest on the basis of the brightness information about the other camera estimated by the brightness information estimating section 24 and the detection result by the detector circuit 21 of the camera of interest.

### [1.2 Operation]

Each of the cameras of the mobile body 101 is movable together with the mobile body 101, and imaging directions of the cameras are changed with movement of the mobile body 101. The mobile body 101 is able to perform a moving operation such as left turning, right turning, upward movement, and downward movement. Control examples of a detection state during such a moving operation are described below with reference to FIGS. 3 to 5.

FIGS. 3 to 5 schematically illustrate first to third examples of control of the detection state by the imaging control device according to the first embodiment.

FIGS. 3 to 5 schematically illustrate a relationship among an imaging screen (sensor output region) 30 of the image sensor 10, the detection frame 31 in the imaging screen 30, and an effective image region 32 in the imaging screen 30 in a case where the mobile body 101 is in a stationary state and in a case where the mobile body 101 is in a moving state. In the stationary state, in general, the detection frame 31 is set at a position slightly inside the effective image region 32 or a position substantially coincident with the effective image region 32. It is to be noted that the size and shape of the detection frame 31 are not limited to the illustrated examples.

FIGS. 3 to 5 schematically illustrate examples in which the mobile body 101 turns left (moves in an X2 direction), turns right (moves in an X1 direction), moves upward (moves in a Y1 direction), and moves downward (moves in a Y2 direction) as moving states. In a case where the mobile body 101 moves (the camera of interest moves), a subject enters inside the imaging screen 30 from side of a direction corresponding to the moving direction.

### First Control Example

FIG. 3 illustrates an example in which the detection controller 22 performs control for changing the position of the detection frame 31 in the imaging screen 30 of the camera of interest as the state of detection on the basis of the moving direction of the camera of interest that is moving (the moving direction of the mobile body 101). In this case, the detection controller 22 performs control for moving the position of the detection frame 31 to side of the moving direction of the camera of interest in the imaging screen 30 of the camera of interest. This makes it possible to quickly follow a change in brightness during movement of the camera of interest.

### Second Control Example

FIG. 4 illustrates an example in a case where a plurality of detection regions are set in the detection frame 31 and brightness of each of the plurality of detection regions is detected. FIG. 4 indicates that the larger a numeric value, the larger a weight is. Assigning a weight to each of the plurality of detection regions makes it possible to increase the weight on a detection region of interest, which makes it easy to follow a change in brightness of the detection region of interest. In FIG. 4, it is assumed that a subject of interest is positioned in a middle of the screen in the stationary state, and a weight in the middle is large. It is to be noted that weight values are not limited to the illustrated example.

FIG. 4 illustrates an example in which the detection controller 22 performs weight control for changing the detection weight on each of the plurality of detection regions as the state of detection on the basis of the moving direction of the camera of interest that is moving (the moving direction of the mobile body 101). In this case, the detection controller 22 performs weight control for increasing the weight on a detection region on side of the moving direction of the camera of interest. This makes it possible to quickly follow a change in brightness during movement of the camera of interest.

### Third Control Example

FIG. 5 illustrates, as a third control example, a control example in which the first control example and the second control example in FIG. 4 are combined. In other words, FIG. 5 illustrates an example in which the detection controller 22 uses both weight control for changing the detection weight on each of the plurality of detection regions and control for changing the position of the detection frame 31 in the imaging screen 30 as the state of detection on the basis of the moving direction of the camera of interest that is moving (the moving direction of the mobile body 101).

It is to be noted that FIG. 5 illustrates an example in which weight values are the same as those illustrated in FIG. 4; however, the weight values are not limited to the illustrated example.

### Control Example Using Brightness Information about Other Camera

Next, description is given of an example in which the exposure controller 23 calculates an exposure control parameter to be used for exposure control on the camera of interest on the basis of brightness information about the other camera estimated by the brightness information estimating section 24 and a detection result by the detector circuit 21 of the camera of interest with reference to FIGS. 6 to 8

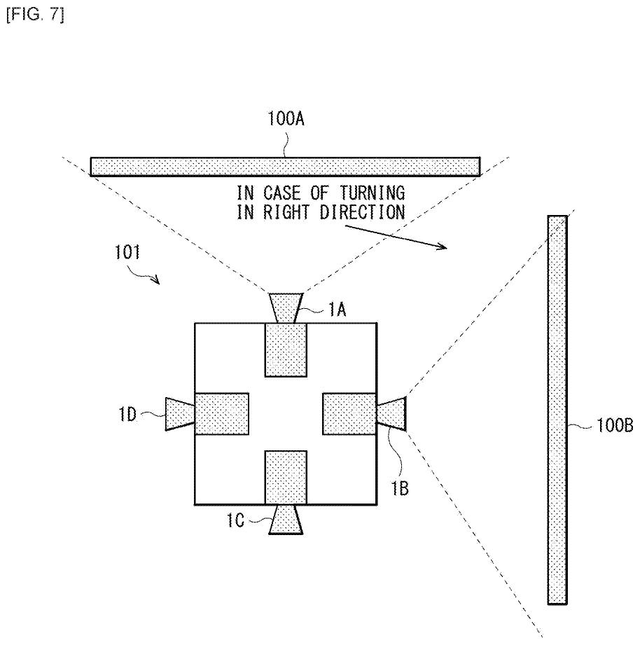

FIG. 7 schematically illustrates an example of a moving state of the mobile body 101 according to the first embodiment. FIG. 7 illustrates an example of the mobile body 101 as viewed from above. FIG. 8 schematically illustrates an example of a method of estimating the brightness information about the other camera.

A case where the mobile body 101 turns in a right direction as illustrated in FIG. 7 is described below as an example. FIG. 8 schematically illustrates an example of a detection frame 31A of the first camera 1A and a detection frame 31B of the second camera 1B. In addition, FIG. 8 schematically illustrates an example of a current angle of view of the first camera 1A and an angle of view of the first camera 1A after one frame by turning. FIG. 8 also schematically illustrates an example of a detection frame region out of the angle of view of the first camera 1A after one frame and a detection frame region entering inside the angle of view of the first camera 1A after one frame.

As illustrated in FIG. 7, in a case where the mobile body 101 turns in the right direction in a state in which the first subject 100A is capturing an image of the first subject 100A and the second camera 1B is capturing an image of the second subject 100B, the second subject 100B whose image is currently being captured by the second camera 1B is to enter inside the angle of view of the first camera 1A. Accordingly, the brightness information estimating section 24 estimates brightness information about the second camera 1B by obtaining a detection result of a detection frame region that is to enter the angle of view after one frame from the second camera 1B that is the other camera in a turning direction, and a current gain amount. Then, the exposure controller 23 calculates an exposure control parameter to be used for exposure control on the first camera 1A on the basis of a result obtained by combining brightness information about the first camera 1A that is the camera of interest and the brightness information about the second camera 1B that is the other camera.

FIG. 6 schematically illustrates an example of a flow of the exposure control process by the imaging control device (the ISP 20) according to the first embodiment.

First, the exposure controller 23 calculates the turning speed of the camera of interest on the basis of movement control information from the AP 2 (step S101). Next, the exposure controller 23 determines whether or not a subject that is to enter the angle of view after one frame is caught by the other camera in the turning direction (step S102).

In a case where the exposure controller 23 determines that the subject that is to enter the angle of view after one frame is not caught by the other camera in the turning direction (step S102; N), the detection controller 22 next controls the position and weight of the detection frame 31 of the camera of interest (step S103). Next, the exposure controller 23 calculates the exposure control parameter from a detection result of the camera of interest (step S107). Next, the exposure controller 23 sets the calculated exposure control parameter in the image sensor 10 (step S108).

In contrast, in a case where the exposure controller 23 determines that the subject that is to enter the angle of view after one frame is caught by the other camera in the turning direction (step S102; Y), the brightness information estimating section 24 next obtains a detection result of a detection frame region that is to enter the angle of view in the next frame and a current gain amount from the other camera in the turning direction (step S104). Next, the brightness information estimating section 24 estimates brightness information from the other camera from the detection result obtained from the other camera and the current gain amount obtained from the other camera (step S105). Next, the exposure controller 23 combines the brightness information about the other camera with the detection result (brightness information) of the camera of interest (step S106). Next, the exposure controller 23 calculates the exposure control parameter from such a combined detection result (brightness information) (step S107). Next, the exposure controller 23 sets the calculated exposure control parameter in the image sensor 10 (step S108).

[1.3 Effects]

As described above, according to the imaging control device, the imaging control method, and the mobile body according to the first embodiment, in a case where the exposure control parameter to be used for exposure control on the first camera 1A is calculated on the basis of the detection result of brightness of an image captured by the movable first camera 1A, the state of detection is changed on the basis of the moving direction of the first camera 1A that is moving, which makes it possible to perform appropriate exposure control even in a case where the first camera 1A moves.

According to the imaging control device, the imaging control method, and the mobile body according to the first embodiment, in a device having a camera whose direction is freely changed in up, down, right and left directions, increasing priority upon calculation of the exposure control parameter on side of the moving direction during movement of the camera makes it possible to improve responsivity upon turning. This makes it possible to improve speed of following a change in brightness of a screen in a case where the direction of the camera is suddenly changed.

### COMPARATIVE EXAMPLES

PTL 1 (Japanese Unexamined Patent Application Publication No. 2014-27587) discloses a technology in which upon receiving an instruction for rotation exceeding a mechanically rotatable limit angle from a user, a region of interest for the user is determined as being not in a middle of an angle of view but in a rotation direction and a detection frame is brought close to an “expected region of interest”. In this technology, movement of the detection frame is not performed during movement in a rotatable range. In contrast, the technology according to the first embodiment differs from the technology described in PTL 1 in that the detection frame is moved during movement to enhance following performance during movement of the camera.

An object of the technology described in PTL 2 (Japanese Unexamined Patent Application Publication No. 2013-126091) is to suppress a change in a captured image to avoid giving a sense of discomfort to a user. In contrast, an object of the technology according to the first embodiment is to increase following speed to allow for quick object detection by a computer without placing importance on the sense of discomfort to the user (human); therefore, the technology according to the first embodiment differs from the technology described in PTL 2 in that a captured image is drastically changed.

PTL 3 (Japanese Unexamined Patent Application Publication No. 2004-7580) discloses a technology in which two exposure setting states different depending on presence or absence of an ND filter are owned in advance and exposure setting is switched by control from outside. In contrast, the technology according to the first embodiment differs from the technology described in PTL 3 in that a technique is adopted of quickly obtaining an exposure target from outside without owning exposure setting.

It is to be noted that the effects described herein are merely illustrative and non-limiting, and other effects may be included. The same applies to effects of the following other embodiments.

### 2. Other Embodiments

The technology according to the present disclosure is not limited to description of the embodiments described above, and may be modified in a variety of ways.

For example, the present technology may have the following configurations.
According to the present technology having the following configurations, in a case where an exposure control parameter to be used for exposure control on a movable first camera is calculated on the basis of a detection result of brightness of an image captured by the first camera, the state of detection is changed on the basis of the moving direction of the first camera that is moving, which makes it possible to perform appropriate exposure control even in a case where the camera moves.
   (1)

An imaging control device including:
a detector circuit that sets a detection frame in an imaging screen of a first camera that is movable, and performs detection of brightness of an image captured by the first camera;
an exposure controller that calculates an exposure control parameter to be used for exposure control on the first camera on the basis of a detection result by the detector circuit; and
a detection controller that changes a state of detection by the detector circuit on the basis of a moving direction of the first camera that is moving.
   (2)

The imaging control device according to (1), in which
the detector circuit sets a plurality of detection regions in the detection frame and performs detection of brightness of each of the plurality of detection regions, and
the detection controller performs weight control for changing a detection weight on each of the plurality of detection regions as the state of the detection.
   (3)

The imaging control device according to (2), in which the detection controller performs weight control for increasing a weight on the detection region on side of the moving direction of the first camera.

(4)

The imaging control device according to (1), in which the detection controller performs control for changing a position of the detection frame in the imaging screen as the state of the detection.

(5)

The imaging control device according to (4), in which the detection controller performs control for moving the position of the detection frame to side of the moving direction of the first camera in the imaging screen.

(6)

The imaging control device according to (1), in which the detector circuit sets a plurality of detection regions in the detection frame, and performs detection of brightness of each of the plurality of detection regions, and the detection controller performs, as the state of the detection, weight control for changing a detection weight on each of the plurality of detection regions and control for changing a position of the detection frame in the imaging screen.

(7)

The imaging control device according to any one of (1) to (6), further including a brightness information estimating section that estimates brightness information about a second camera of which a current imaging screen is expected to include a future imaging range of the first camera, in which
the exposure controller calculates the exposure control parameter to be used for exposure control on the first camera on the basis of the brightness information about the second camera estimated by the brightness information estimating section and the detection result by the detector circuit.
   (8)

An imaging control method including:
setting a detection frame in an imaging screen of a first camera that is movable and performing detection of brightness of an image captured by the first camera;
calculating an exposure control parameter to be used for exposure control on the first camera on the basis of a detection result of the brightness; and
changing a state of the detection on the basis of a moving direction of the first camera that is moving.
   (9)

A mobile body including:
a first camera;
a detector circuit that sets a detection frame in an imaging screen of the first camera, and performs detection of brightness of an image captured by the first camera;
an exposure controller that calculates an exposure control parameter to be used for exposure control on the first camera on the basis of a detection result by the detector circuit; and
a detection controller that changes a state of detection by the detector circuit on the basis of a moving direction of the first camera that is moving.
   (10)

The mobile body according to (9), further including:
a second camera; and
a brightness information estimating section that estimates brightness information about the second camera in a case where a future imaging range of the first camera is expected to be included in a current imaging screen of the second camera, in which
the exposure controller calculates a exposure control parameter to be used for exposure control on the first camera on the basis of the brightness information about the second camera estimated by the brightness information estimating section and the detection result by the detector circuit.

This application claims the priority on the basis of Japanese Patent Application No. 2020-160881 filed on Sep. 25, 2020 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. An imaging control device comprising:
a detector circuit that sets a detection frame in an imaging screen of a first camera that is movable, and performs detection of brightness of an image captured by the first camera;
an exposure controller that calculates an exposure control parameter to be used for exposure control on the first camera on a basis of a detection result by the detector circuit; and
a detection controller that changes a state of detection by the detector circuit on a basis of a moving direction of the first camera that is moving.

2. The imaging control device according to claim 1, wherein
the detector circuit sets a plurality of detection regions in the detection frame and performs detection of brightness of each of the plurality of detection regions, and
the detection controller performs weight control for changing a detection weight on each of the plurality of detection regions as the state of the detection.

3. The imaging control device according to claim 2, wherein the detection controller performs weight control for increasing a weight on the detection region on side of the moving direction of the first camera.

4. The imaging control device according to claim 1, wherein the detection controller performs control for changing a position of the detection frame in the imaging screen as the state of the detection.

5. The imaging control device according to claim 4, wherein the detection controller performs control for moving the position of the detection frame to side of the moving direction of the first camera in the imaging screen.

6. The imaging control device according to claim 1, wherein
the detector circuit sets a plurality of detection regions in the detection frame, and performs detection of brightness of each of the plurality of detection regions, and
the detection controller performs, as the state of the detection, weight control for changing a detection weight on each of the plurality of detection regions and control for changing a position of the detection frame in the imaging screen.

7. The imaging control device according to claim 1, further comprising a brightness information estimating section that estimates brightness information about a second camera of which a current imaging screen is expected to include a future imaging range of the first camera, wherein
the exposure controller calculates the exposure control parameter to be used for exposure control on the first camera on a basis of the brightness information about the second camera estimated by the brightness information estimating section and the detection result by the detector circuit.

8. An imaging control method comprising:
setting a detection frame in an imaging screen of a first camera that is movable and performing detection of brightness of an image captured by the first camera;
calculating an exposure control parameter to be used for exposure control on the first camera on a basis of a detection result of the brightness; and
changing a state of the detection on a basis of a moving direction of the first camera that is moving.

9. A mobile body comprising:
a first camera;
a detector circuit that sets a detection frame in an imaging screen of the first camera, and performs detection of brightness of an image captured by the first camera;
an exposure controller that calculates an exposure control parameter to be used for exposure control on the first camera on a basis of a detection result by the detector circuit; and
a detection controller that changes a state of detection by the detector circuit on a basis of a moving direction of the first camera that is moving.

10. The mobile body according to claim 9, further comprising:
a second camera; and
a brightness information estimating section that estimates brightness information about the second camera in a case where a future imaging range of the first camera is expected to be included in a current imaging screen of the second camera, wherein
the exposure controller calculates a exposure control parameter to be used for exposure control on the first camera on a basis of the brightness information about the second camera estimated by the brightness information estimating section and the detection result by the detector circuit.
